(19) United States
(12) Patent Application Publication
(10) Pub. No.: US 2008/0214248 A1
(43) Pub. Date: Sep. 4, 2008

(54) Auxiliary power supply for a cell phone

(76) Inventor: Howard Charles Hensel, Naples, FL (US)

Correspondence Address: Howard Charles Hensel, P. O. Box 990182, Naples, FL, 34116, US

(21) Appl. No.: 11/712,934

(22) Filed: Mar. 2, 2007

(51) Int. Cl. H04M 1/00

(52) U.S. Cl. 455/572

(57) ABSTRACT

An auxiliary power is supplied for use on a cell phone in case the power is lost or not available in an emergency. The auxiliary power supply consists of a casing having a spare battery therein. One end of the casing has a plug-in thereon that will fit into the receptacle for the charging cable that is normally used. The battery in the casing will now be instrumental in powering the cell phone. The other end of the casing has a ring attached thereto that can be used to attach the casing to a key chain as a standby in case an emergency arises and the internal power of the cell phone is lost.

### BACKGROUND OF THE INVENTION

Cell phones may be operated in two different modes. Both modes are well known. The first one is by way of an adapter that can be plugged into any regular current outlets and will provide continuous power. The second mode is to supply power to the cell phone by way of a battery. Of course, batteries will only last so long before the battery needs to be recharged again or to be replaced. The duration of a life of a battery depends on the quality of the battery or how often the cell phone is in use or how long a cell phone is in an “on” condition without being used.

Recent news events have described mountain climbers being stranded on a mountain in a snow storm and complete adverse weather conditions. It appears that there was a cell phone available and in use but only for so long because, apparently, the battery lost its power rendering the cell phone useless. Of course, there can be other and various instances where a cell phone comes in handy in emergency situations while the battery will only last that long. For example, accidents on land and sea require a cell phone to alert authorities to the problem at hand. It may take quite awhile to identify and locate the emergency. The ensuing conversation on the cell phone may be instrumental in discharging the battery.

### BRIEF DESCRIPTION OF THE INVENTION

The invention at hand provides a simple solution to the above noted problem. The inventive concept simply provides for the use of an auxiliary or spare battery. It is not known for any body to carry a spare battery either in a pocket, a wallet or a hand bag. In addition, the batteries are so small so that they easily can get lost. the inventive concept suggests that a spare battery be enclosed in a small container and having at one end a retainer ring that can easily be attached to a similar ring on the cell phone container or on a key chain which is in every body's possession. The other end of the small container or casing having the spare battery therein has a connector thereon that is exactly like the plug-in end of a charger. In this manner there is always a spare battery available, when the need arises, and the spare battery cannot be lost and is carried unobtrusively and is not in anybody's way.

### BRIEF DESCRIPTION OF THE DRAWINGS

FIG. 1 illustrates a casing having a current plug-in at one end and a carrying ring at another and a battery contained in the casing;

FIG. 2 shows a cell phone with an auxiliary battery casing installed;

FIG. 3 shows an auxiliary battery casing prior to installation;

FIG. 4 illustrates an auxiliary battery casing having a different plug-in end.

### DETAILED DESCRIPTION OF THE INVENTION

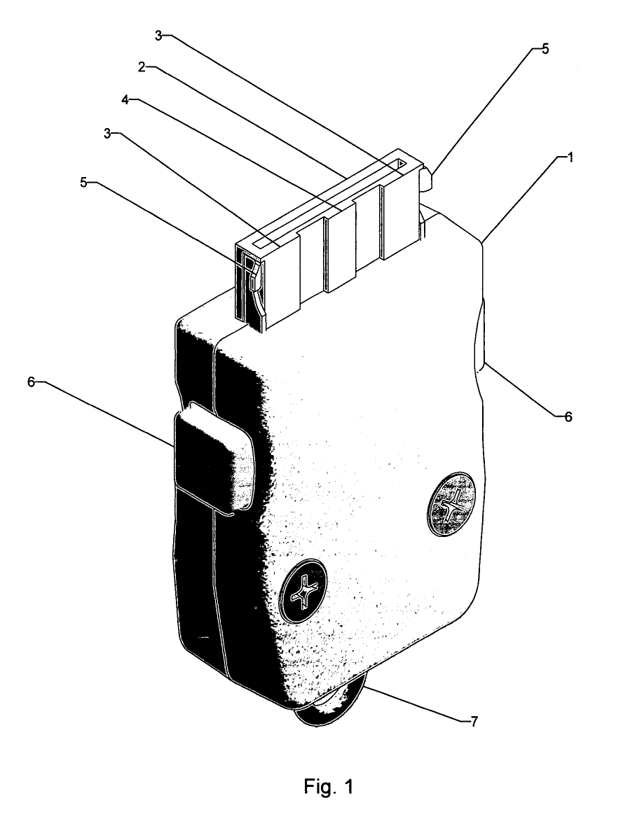

FIG. 1 shows the auxiliary battery case 1 with the typical plug-in end 2 in lieu of the well known charging receptacle 2 located at the end of a charging cord. The charging end 2 has orientation flanges 3 and 4 thereon to ensure the polarity of the current when the plug-in end of the battery casing is inserted into the one end of the cell phone casing 8. The extending plug-in end 2 also has protruding clips on lateral sides thereof which will be arrested within retainers of the receptacle 8a of the cell phone 8. When it is desired to remove the battery case from the cell phone, it is merely up to the operator to push the release buttons 6 which will retract the clips 5 to thereby release the battery casing 1 from the cell phone body 8. The other end of the battery casing 1 has a ring 7 thereon which may be used to attach the battery casing 1 to key chain (not shown).

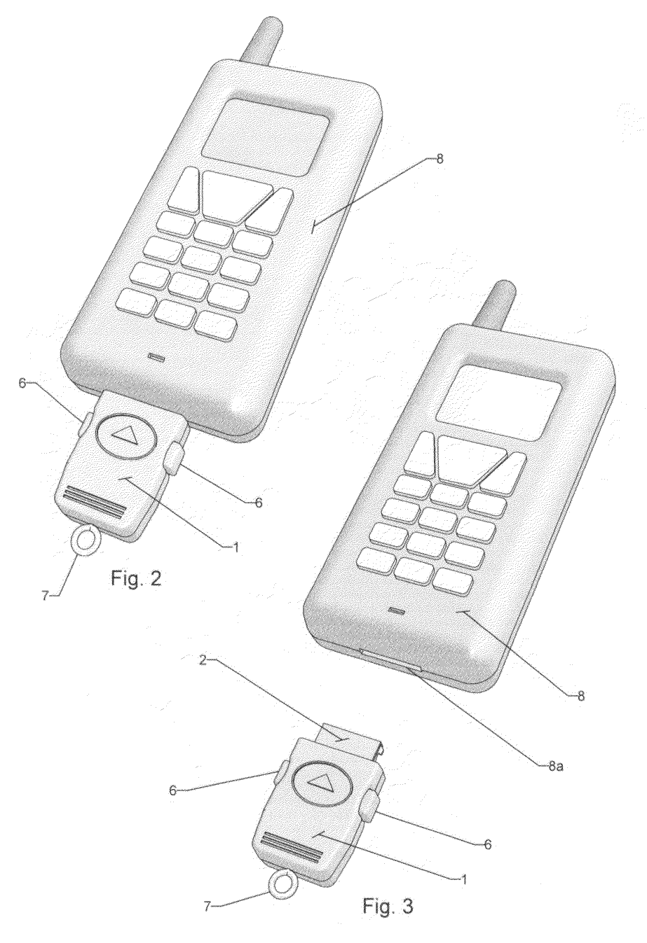

FIG. 2 shows the auxiliary battery casing 1 installed on the cell phone 8, while FIG. 3 shows the auxiliary casing 1 removed there from. Like reference characters have been used in both Figs.

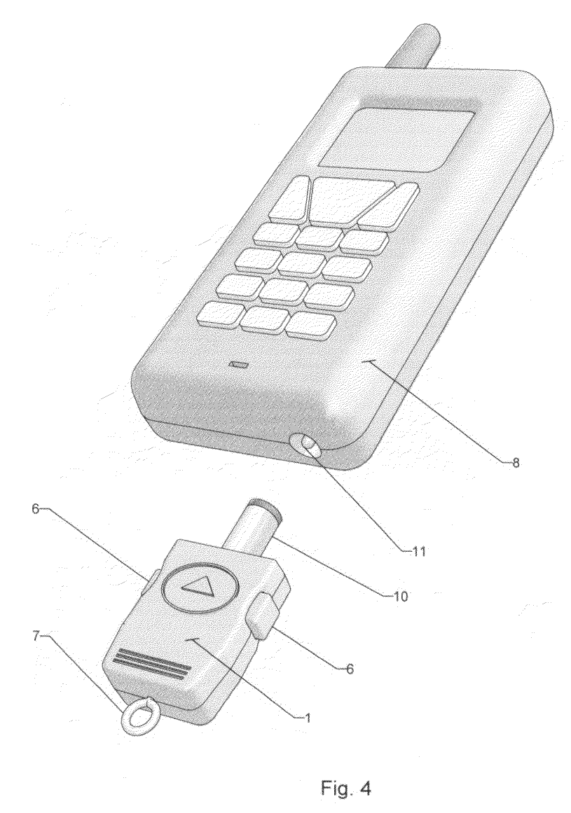

FIG. 4 shows the same concept as was illustrated in previous Figs. However the difference in this embodiment is that the battery casing 1 has been modified to be able to be attached or plugged into a cell phone that has a different charge plug-in end. This embodiment has a round receptacle that will normally receive the end of a charging cord that has coaxial wires. The insert end 10 of the battery case 1 has also a coaxial plug-in the form of a coaxial pin whereby the polarity of the charging of the charging wire and/or the battery casing does not have to be observed.

In view of all of the above, it can now be seen that the inventive concept solves a potential and serious problem in a very simple and inexpensive manner.

What I claim is:

1. A cell phone and auxiliary battery combination comprising: an auxiliary battery contained in a casing, said casing having at one end thereof a plug-in designed to be plugged into a charging end of said cell phone, said casing having a retaining ring at another end of said casing, wherein said plug-in has means thereon to observe a polarity of the cell phone current.

2. The combination of claim 1, wherein said plug-in has orientations in a form of flanges which match similar flanges in a receptacle on said cell phone.

3. The combination of claim including means for arresting said plug-in after having been inserted into the receptacle of said cell phone.

4. The combination of claim 3, including means for releasing said plug-in from said arresting from said cell phone/

5. The combination of claim 1, wherein said orientation consists of a coaxial plug-in pin on said battery casing.
